(19) United States
(12) Patent Application Publication
(10) Pub. No.: US 2005/0255233 A1
(43) Pub. Date: Nov. 17, 2005

(54) High aspect ratio C-MEMS architecture

(75) Inventors: Marc J. Madou, Irvine, CA (US); Chunlei Wang, Irvine, CA (US); Guangyao Jia, Irvine, CA (US); Lili Taherabadi, Irvine, CA (US); Benjamin Park, Irvine, CA (US); Rabih Zaouk, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: The Regents of the University of California

(21) Appl. No.: 11/057,389

(22) Filed: Feb. 11, 2005

Related U.S. Application Data
(60) Provisional application No. 60/544,004, filed on Feb. 11, 2004.

(51) Int. Cl. B05D 5/12

(52) U.S. Cl. 427/96.1

(57) ABSTRACT

C-MEMS architecture having high aspect ratio carbon structures and improved systems and methods for producing high aspect ratio C-MEMS structures are provided. Specifically, high aspect ratio carbon structures are microfabricated by pyrolyzing a patterned carbon precursor polymer. Pyrolysing the polymer preferably comprises a multi-step process in an atmosphere of inert and forming gas at high temperatures that trail the glass transit temperature (Tg) for the polymer. Multi-layer C-MEMS carbon structures are formed from multiple layers of negative photoresist, wherein a first layer forms carbon interconnects and the second and successive layers form high aspect ratio carbon structures. High-conductivity interconnect traces to connect C-MEMS carbon structures are formed by depositing a metal layer on a substrate, patterning a polymer precursor on top of the metal layer and pyrolyzing the polymer to create the final structure. The interconnects of a device with high aspect ratio electrodes are insulated using a self aligning insulation method.

### CROSS-REFERENCE TO RELATED APPLICATIONS

This application claims the benefit of U.S. Provisional Application No. 60/544004, filed Feb. 11, 2004, which is fully incorporated by reference herein.

This invention was made with Government support under Grant No. DMI-0428958 awarded by the National Science Foundation. The Government has certain rights in this invention.

### FIELD OF THE INVENTION

The present invention relates to high aspect ratio carbon structures and, more particularly, to carbon micro-electro-mechanical-systems (C-MEMS) having high aspect ratio carbon structures forming microelectrode arrays for use in electrochemical systems, and systems and methods for producing high aspect ratio C-MEMS.

### BACKGROUND OF THE INVENTION

Highly ordered graphite as well as hard and soft carbons are used extensively as the negative electrodes of commercial Lithium (Li) ion batteries. The high energy density values reported for these Li batteries are generally based on the performance of larger cells with capacities of up to several ampere-hours. For small microbatteries, with applications in miniature portable electronic devices, such as cardiac pacemakers, hearing aids, smart cards and remote sensors, the achievable power and energy densities do not scale favorably because packaging and internal battery hardware have a greater effect on the overall size and mass of the completed battery. One approach to overcome the size and energy density deficiencies in current two dimensional (2D) microbatteries is to develop three dimensional (3D) battery architectures based on specially designed arrays composed of high aspect ratio three dimensional (3D) electrode elements. For example, a micro 3D battery which has electrode arrays with a 50:1 aspect ratio (height/width), the expected capacity may be 3.5 times higher and the surface area 350 times higher than for a conventional 2D battery design. The key challenge, however, in fabricating 3D microbatteries based on carbon negative electrodes is in achieving high aspect ratio electrodes, i.e., electrodes with aspect ratios preferably greater than 10:1, to ensure a dramatic improvement in surface-to-volume ratio without a corresponding increase in overall volume and providing a reduced footprint, e.g., less than one cm², without compromising capacity.

As such, significant attention has recently been focused on carbon micro-electro-mechanical-systems (C-MEMS). Yet, microfabrication of C-MEMS carbon structures using current processing technology, including focus ion beam (FIB) and reactive ion etching (RIE), tends to be time consuming and expensive. Low feature resolution, and poor repeatability of the carbon composition as well as the widely varying properties of the resulting devices limits the application of screen printing of commercial carbon inks for C-MEMS. One promising C-MEMS microfabrication technique, however, is based on the pyrolysis of photo patterned resists (photoresists) at different temperatures and different ambient atmospheres. The advantage of using photoresists as the starting material for the microfabrication of various carbon structures is that the photoresists can be very finely patterned by photolithography techniques and hence a wide variety of repeatable shapes are possible. Moreover different temperature treatments result in different resistivities and mechanical properties. Some important C-MEMS properties include: the material has a very wide electrochemical stability window, it exhibits excellent biocompatibility, is low cost, is very reproducible, very fine geometries can be defined as opposed to the more traditionally used printing of carbon inks, a wide range of resistivities and mechanical properties can be obtained, and the surface of this very chemically inert material is easy to derivatize. The material has particular importance in bio-MEMS applications including DNA arrays, glucose sensors, and micro batteries.

Most pyrolyzed photoresist structures described in the literature today concern carbon features derived from positive photoresist and are very low aspect ratio. (E.g., see FIG. 5). The fabrication of high aspect ratio and dense C-MEMS patterns is a challenging problem because with increasing photoresist thickness, the requirements of any lithography process increase exponentially. Basically, it is very difficult to design a thick positive tone photoresist chemistry to achieve the necessary transparency and to achieve reasonable exposure doses while maintaining excellent sidewall angles. The LIGA process in which PMMA resist is exposed with an x-ray source is capable of structures of the order of 1 mm. However, this technique requires an expensive synchrotron source, hence the motivation for cheaper and easier processes.

Although pyrolysis of negative photoresist has been suggested in literature, there has been no recorded success involving the pyrolysis of negative photoresist to produce high aspect ratio carbon structures. The most common reason for failure is that the carbonized structures or posts tend to peel away from the substrate during the pyrolysis process.

Accordingly, it would be desirable to provide high aspect ratio carbon microelectrodes for use in microelectrode arrays for electrochemistry systems such as 3D microbatteries and the like, and provide improved methods for producing high aspect ratio carbon microelectrodes.

### SUMMARY OF THE INVENTION

The present invention provides an improved C-MEMS architecture having high aspect ratio carbon structures and improved systems and methods for producing high aspect ratio C-MEMS structures.

In one embodiment, which is described below as an example only and not to limit the invention, high aspect ratio carbon posts having aspect ratios greater than 10:1, are microfabricated by pyrolyzing polymer posts patterned from a carbon precursor polymer. The pyrolysing step preferably comprises a multi-step pyrolysis process in an atmosphere of inert and forming gas at high temperatures that trail the glass transition temperature (Tg) for the polymer. Alternatively, the pryrolyzing step can comprise a slow continuous ramping of the furnace temperature such that the temperature always trails Tg.

In another embodiment, which is described below as an example only and not to limit the invention, carbon interconnects and high aspect ratio carbon posts having aspect ratios greater than 10:1, are microfabricated by pyrolyzing polymer posts and interconnects patterned from multiple layers of a carbon precursor polymer. In addition, each carbon post can microfabricated by pyrolyzing two or more polymer posts stacked on top of one another and patterned from multiple layers of a carbon precursor polymer.

In yet another embodiment, which is described below as an example only and not to limit the invention, high aspect ratio carbon posts having aspect ratios greater than 10:1, are microfabricated by pyrolyzing negative photoresist. The pyrolysing step preferably comprises a multi-step pyrolysis process in an atmosphere of inert and forming gas at high temperatures that trail Tg for the photoresist. Carbon interconnects and carbon posts having high aspect ratios can be microfabricated by pyrolyzing polymer posts and interconnects patterned from multiple layers of negative photoresist.

The high aspect ratio carbon structures formed in accordance with the processes described herein can advantageously be used to form 3D carbon electrode arrays suitable for use in electrochemical systems. The pyrolyzed patterned carbon precursor polymers, such as negative photoresists, can be used as current collectors and electrodes in electrochemical cells, 3D carbon microelectrode arrays for three dimensional micro battery applications, or interconnected with C-MEMS leads to enable smart power management schemes. Lithium can be reversibly charged and discharged into these C-MEMS electrodes with higher capacity per unit area than unpatterned carbon films.

In yet another embodiment, which is described below as an example only and not to limit the invention, a process used to create high-conductivity interconnect traces to connect C-MEMS carbon structures includes depositing a metal layer, such as Ag, Au, Pt, Ti, and the like, on a substrate. The metal is then patterned and a polymer precursor is then patterned on top of the metal layer and pyrolyzed to create the final structure as described above. The polymer precursor can be a negative photoresist such as SU-8 and the like, and can be patterned and then pyrolyzed in accordance with the method described above.

In yet another further embodiment, which is described below as an example only and not to limit the invention, an insulation method involves applying a photoresist onto the interconnects and the high-aspect ratio electrodes of a high-aspect ratio device. A photolithographic process is utilized in an aligner to remove photoresist that is on and in the vicinity of the high-aspect-ratio electrodes. Finally, the photoresist layer is hard-baked at a temperature higher than the glass transition temperature to allow the layer to flow. The photoresist layer then flows until it reaches the bottom of the high-aspect-ratio electrodes creating a self-aligned insulation layer over and about the interconnects.

Further systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. It is also intended that the invention is not limited to the details of the example embodiments.

### BRIEF DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1A is a schematic showing the fabrication process for producing high aspect ratio C-MEMS in accordance with one embodiment.

FIG. 1B is a graph showing the pyrolyzing of the fabrication process depicted in FIG. 1A.

FIG. 2 is a schematic of a pyrolyzing furnace for use in step 2 of the process depicted in FIG. 1.

FIG. 3 is a schematic showing the fabrication process for producing high aspect ratio C-MEMS in accordance with another embodiment.

FIGS. 4A and 4B are SEM photographs of (4A) photoresist and (4B) carbon structures before and after pyrolysis that were produced in accordance with the process illustrated in FIG. 3.

FIG. 5 is a SEM photograph of a low aspect ratio C-MEMS structure formed from positive photoresist (AZ4620).

FIGS. 6A, 6B and 6C are SEM photos of carbon posts fabricated on different substrates using different mask designs: (a) SiN, Ø20 μm, C—C: 100 μm; (b) Au/Ti/SiO₂/Si, Ø50 μm, C—C: 100 μm and (c) SiN, Ø30 μm, C—C: 100 μm.

FIGS. 7A and 7B are graphs illustrating (7A) the galvanostatic charge/discharge cycle behavior of patterned carbon arrays and (7B) the cyclic voltammetry of patterned carbon arrays.

FIGS. 8A and 8B are perspective views of (8A) an assembly of a C-MEMS based carbon electrode array and carbon current collector for use in an electrochemical systems such as 3D batteries and (8B) the C-MEMS based carbon current collector of the assembly.

FIG. 9 is a schematic showing the fabrication process for producing multi-layer carbon structures comprising high aspect ratio C-MEMS posts and interconnects in accordance with another embodiment.

FIG. 10 is a schematic showing the fabrication process for producing multi-layer carbon structures comprising high aspect ratio C-MEMS posts and interconnects in accordance with another embodiment.

FIGS. 11A and 11B are SEM photos showing (11A) a close-up view and (11B) a low magnification of a two layer SU-8 structure. In this structure, the first layer was patterned to be an interconnect layer, and the second layer was patterned to be micro electrodes (posts).

FIGS. 12A and 12B are SEM photos showing (12A) a close-up view and (12B) a low magnification view of two layer carbon structures corresponding to the structures in FIGS. 11A and 11B after pyrolysis.

FIGS. 13A and 13B are SEM photos showing (13A) a three layer SU-8 structure with the first layer patterned to be an interconnect layer, and the second and third layers were patterned sequentially to achieve higher aspect ratio micro electrodes (posts) for use in microbattery experiments; and (13B) a three layer carbon structure corresponding to the structure in FIG. 13A after pyrolysis.

FIG. 14 is a graph showing the resistivity of carbon films obtained from AZ P4620 photoresist and various-thickness SU-8 films after 1 hour of heat treatment at different temperatures.

FIG. 15 is a schematic showing the fabrication process for self-aligned insulation of interconnects for high-aspect-ratio structures.

FIG. 16 is a SEM photo of high-aspect-ratio C-MEMS electrodes and their interconnects.

FIG. 17 is a SEM photo of high-aspect-ratio C-MEMS electrodes protruding from an insulating layer.

FIG. 18 is a close-up SEM photo of one of the high-aspect-ratio C-MEMS electrodes protruding from an insulating layer shown in FIG. 19.

FIG. 19 is a graph illustrating sheet resistance (Ohm/square) for OCG-825 photoresist.

### BRIEF DESCRIPTION OF THE INVENTION

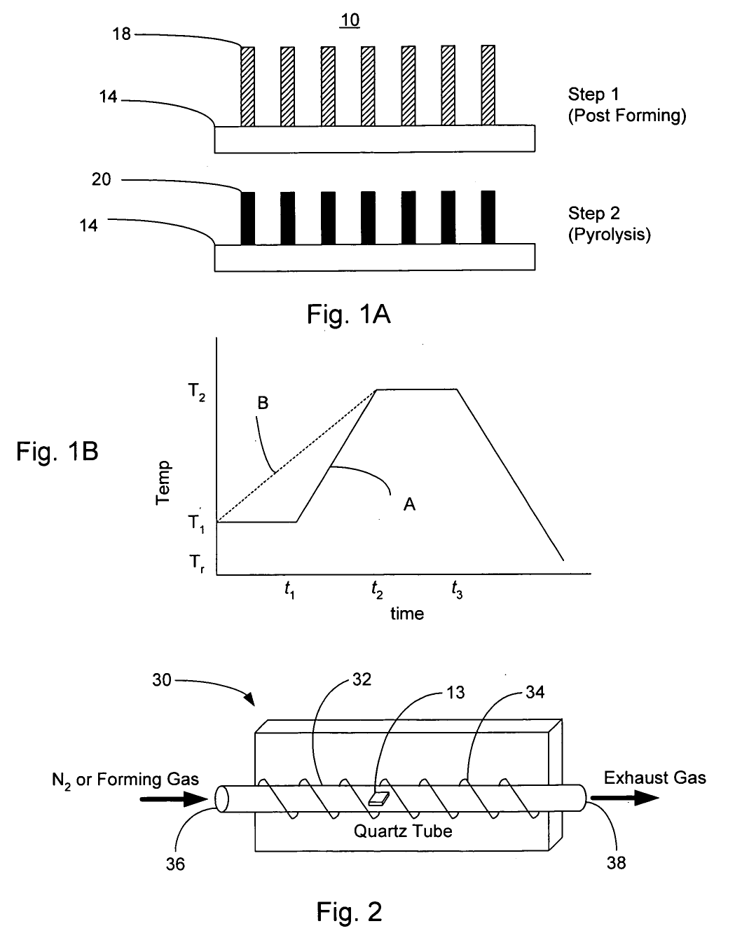

Referring in detail to the figures, the systems and methods described herein facilitate the production of high aspect ratio carbon-micro-electro-mechanical systems (C-MEMS) structures. In one embodiment, as depicted in FIGS. 1A and 1B, high aspect ratio carbon posts, having aspect ratios greater than 10:1, are microfabricated by pyrolyzing polymer posts patterned from a carbon precursor polymer. In step 1 of the process 10, polymer posts 18 are patterned or formed in an array on a substrate 14. The posts 18 can be formed by a variety of processes including, but not limited to, photolithography, soft lithography methods including stamping or micro contact printing, hot embossing or nanoimprinting, step and flash lithography, micro injection molding and the like, silk screening, spray deposition techniques including plasma spraying and the like, self-assembly of malleable polymers and liquids using electric fields, van der Waals forces and the like, x-ray patterning, and the like.

The pyrolyzing step (step 2) is preferably conducted, as depicted in FIG. 2, in an open ended quartz tube furnace 30. The furnace 30 includes an open ended quartz tube 32 with a heating element 34 coupled thereto. During the pyrolyzing process, a wafer or sample 13 with patterned precursor polymer post is placed within the quartz tube 32. Inert gas, such as nitrogen (N₂), and forming gas, such as hydrogen (5%)/nitrogen (H₂(5%)/N₂), enter the tube 32 at one end 36, while exhaust gas exits the tube 32 at the other end 38.

Referring to FIG. 1B, the pyrolysis process of step 2 preferably comprises a multi-step pyrolysis process conducted in an atmosphere of inert and forming gas at high temperatures that trail the glass transition temperature Tg of the polymer posts 18. As depicted by curve A, the wafer 13 is baked at a first temperature T₁ for a predetermined time t₁ in an inert atmosphere. The wafer 13 is then heated up to a second temperature T₂ in an inert atmosphere at a predetermined gas flow rate through the quartz tube 32. The temperature of the furnace 30 is preferably slowly ramped up from the first temperature T₁ to the second temperature T₂. A heating rate of preferably about 10° C./min has been used. When the furnace 30 reaches the second temperature T₂, the inert gas is shut off and forming gas is introduced at a predetermined gas flow rate for a predetermined time period t₂-t₃. At the end of this time period t₃, the heating element 34 is turned off and the wafer 13 is allowed to cool down in an inert atmosphere to room temperature Tᵣ. The total cooling time is about 8-9 hours.

Alternatively, as depicted by curve B, the pryrolyzing step can comprise a slow continuous ramping of the furnace temperature from the first temperature T₁ to the second temperature T₂, wherein the heating temperature always trails the glass transition temperature Tg of the polymer posts 18. The sample 13 is heated in an inert atmosphere as the furnace temperature ramps up from T₁ to T₂. Once the furnace temperature reaches T₂, the pyrolysis process proceeds as detailed in regard to curve A. In a further alternative, the pyrolysis process can include multiple heating steps between temperatures T₁ and T₂ along curve A.

In a single step pyrolysis process with heating at high temperatures in a vacuum furnace, pyrolyzed polymer post patterns tend to peel from the substrate. In the multi-step process described above in which the pyrolysis process is conducted in inert and forming gas, this problem is resolved due to (I) the bake process at the first temperature, which cross-links the polymer better, enhancing adhesion of polymer to the substrate, (II) the multi-step heating process with its slow heating rate, which more effectively releases the stress from the adhesion of the polymer to the substrate which results in tensile stress in the carbon posts near the substrate interface, and (III) the slower de-gassing that occurs in a forming gas atmosphere. Heat-treatment during crosslinking generates gaseous by products arid the subsequent out-gassing may cause the formation of micro-cracks which disintegrate the sample. In a vacuum, this outgassing would tend to be faster and thus more destructive

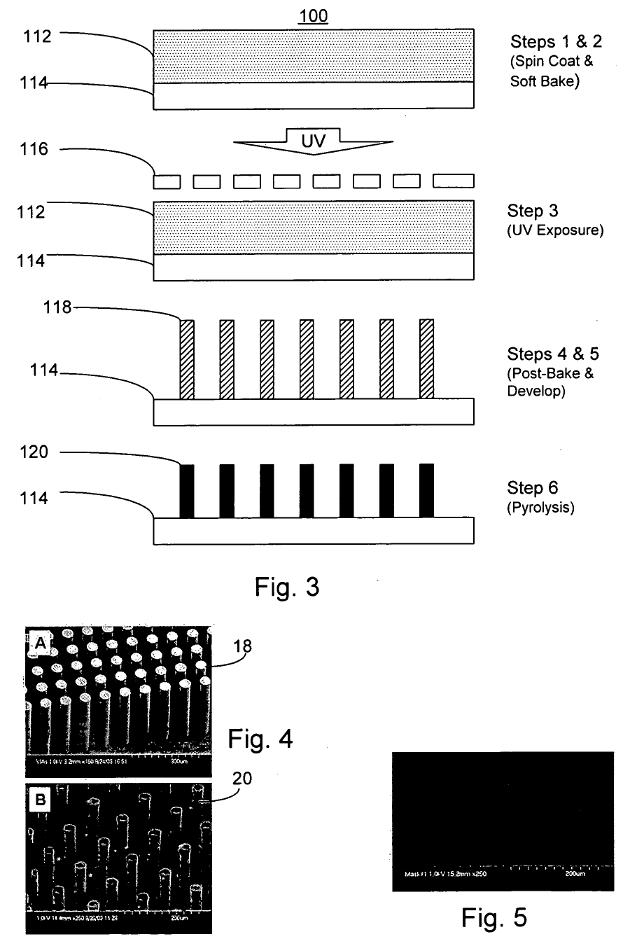

Turning to FIG. 3, in an exemplary embodiment, high aspect ratio carbon posts (>10:1) are microfabricated by preferably pyrolyzing negative photoresist, such as SU 8 and the like, in a simple, one spin-coat step process. A photolithography process 100 for patterning negative photoresist preferably includes the following steps: step 1, spin coating a photoresist film 112 onto a substrate 114; step 2, soft baking the film 112; step 3, near UV exposure of the film 112 with a preferred mask 116; step 4, post baking the exposed film 112; and step 5, developing the exposed film 112 to form an array of posts 118. For example, a typical process for a 200 μm thick SU-8 photoresist film involves spinning at approximately 500 rpm for about 12 seconds then at approximately 1400 rpm for about 30 seconds (step 1), followed by a bake for about 10 minutes at about 65° C. and a bake for about 80 minutes at about 95° C. (step 2). Near UV exposure of the photoresist is then performed, e.g., in a Karl Suss MJB3 contact aligner for about 100 seconds (step 3). The post bake is then carried out for about 2 minutes at about 65° C. and for about 30 minutes at about 95° C. (step 4). Development is then carried out using a SU-8 developer such as a SU-8 developer from MicroChem (NANO™ SU-8 Developer) (step 5). For SU-8 100 photoresist modified with iron oxide particles, an over exposure process was introduced with exposure duration of as much as 5 minutes.

In the pyrolysis step, step 6, of the process 100, photoresist-derived C-MEMS architectures, i.e., carbon posts 120, are then obtained in accordance with the two- or multi-step pyrolysis process depicted and described in regard to FIG. 1B. For example, the pyrolysis process of step 6 is conducted in an open ended quartz-tube furnace, as depicted in FIG. 2, in which samples are preferably baked in an inert gas atmosphere, such as N2, at about 300° C. for about 30-40 minutes first, then heated up to about 900° C.-1000° C. in an inert gas atmosphere, such as N2, at about 2000 standard cubic centimeters per minute (sccm). At this point the N2 gas is shut off and forming gas, such as H2 (5%)/N2, is introduced at about 2000 sccm for about one hour. The heating element 34 on the furnace 30 is then turned off and the samples are cooled down again in N2 atmosphere to room temperature. A heating rate of preferably about 10° C./min has been used, and the total cooling time is about 8-9 hours.

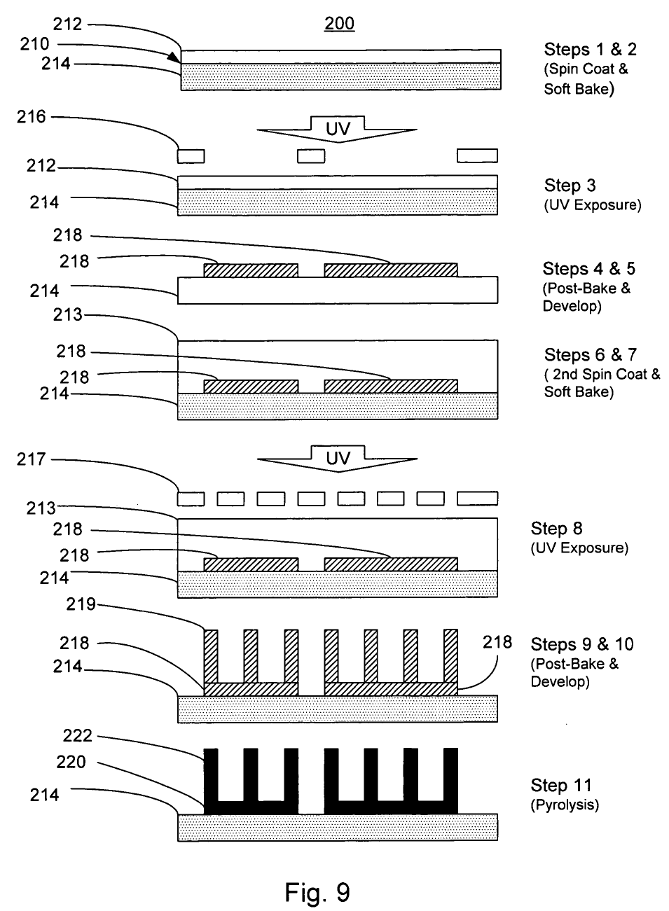

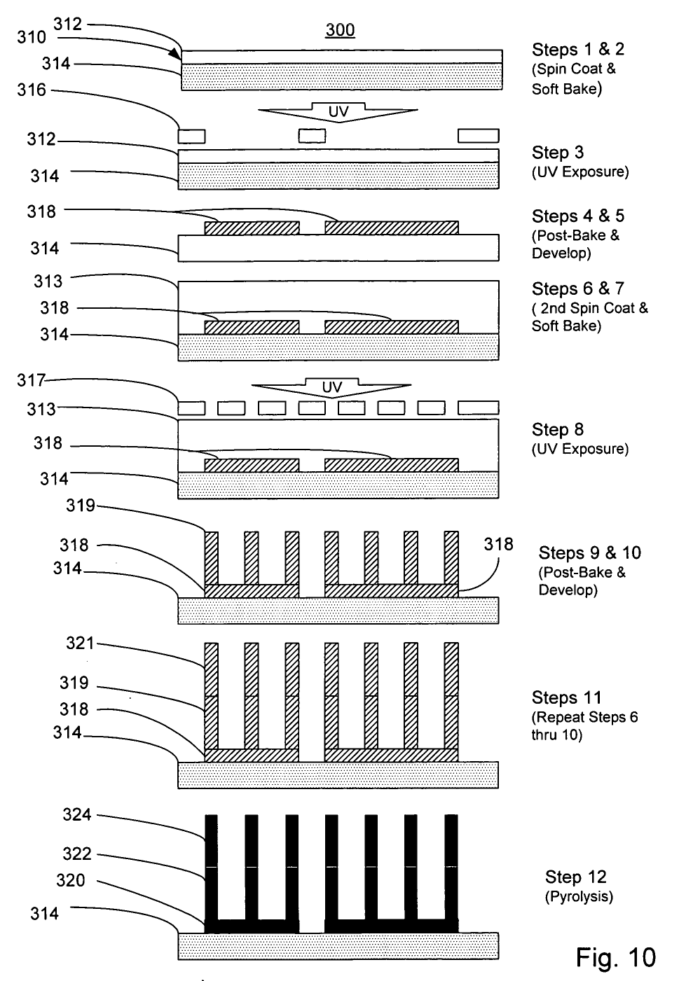

FIGS. 4A and 4B are SEM photographs of SU-8 photoresist posts before pyrolysis and the resulting carbon structures after pyrolysis. As shown in FIG. 4A, a typical SU-8 array of posts on a substrate of Au/Ti/SiO₂/Si is uniform with straight walls and good edge profiles. The average height of the posts shown here is around 340 μm and the average thickness in the midsection of the posts (i.e., the rod diameter) is 50 μm. After pyrolysis the overall structure of the cylindrical posts is largely retained, as shown in FIG. 4B. The height to width (at midsection of the posts) ratio of the pyrolyzed material corresponds to an aspect ratio of 9.4:1. Ratios as high as 20:1, in a one-step spin coat process, and 40:1, in a two step spin coat process have been obtained. Aspect ratios greater than 40:1 are possible with a multi-step spin coat process. (see, e.g., FIGS. 9 and 10).

In other experiments using different substrates such as (1) Si, (2) Si₃N₄(2000 Å)/Si, (3) SiO₂(5000 Å)/Si and (4) Au(3000 Å)/Ti (200 Å)/SiO₂(5000 Å)/Si—Ti, Au layers were deposited by electron beam (EB) evaporation methods—a negative tone photoresist with different thickness, NANO™ SU-8 100, was spin-coated onto the substrates. Two kinds of mask designs were used to generate SU-8 posts: (1) 180 by 180 arrays of circles with diameter of 50, 40, 30 and 20 μm and center to center distance of 100 μm, and (2) 90 by 90 arrays of circles with a diameter of 100 μm and center to center spacing of 200 μm. The photolithography process used for SU-8 photoresist patterning, included spin coating, soft bake, near UV exposure, development and post-bake as discussed above. Photoresist-derived C-MEMS architectures were obtained in accordance with the pyrolysis process discussed above. Each of the samples was baked in a N2 atmosphere at about 300° C. for, about 40 min first, then heated in N2 atmosphere with 2000 sccm flow rate up to about 900° C. The atmosphere was then changed to forming gas, i.e., H2(5%)/N2, flowing at about 2000 sccm rate. The sample was kept at about 900° C. for about one hour, then the heater was turned off and the samples were cooled in N2 atmosphere to room temperature. The heating rate was about 10° C./min.

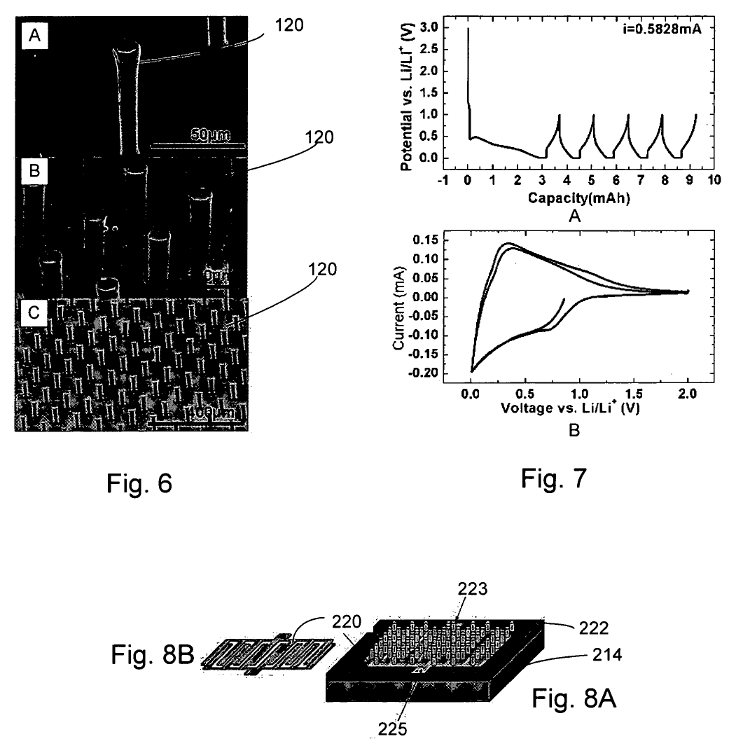

Turning to FIGS. 6A, 6B and 6C, which include SEM photos of carbon posts fabricated on different substrates, with different mask designs and in accordance with the process 100 depicted in FIGS. 3 and 1B: (A) SiN, Ø20 μm, C—C: 100 μm; (B) Au/Ti/SiO₂/Si, Ø50 μm, C—C: 100 μm and (C) SiN, Ø30 μm, C—C: 100 μm. The posts 120 have shrunk much less during the pyrolysis process near the base of the structures than at the midsection due to the good adhesion of SU-8 to the substrate 114. The tops of the posts 120 have shrunk a little less than the midsection as well, which is likely due to overexposure of the top of the posts. The amount of shrinkage the posts 120 experience tends to be dependent on the height of the posts 120. For SU-8 samples whose post heights ranged from 100 to 350 mm, the heights of the corresponding carbon posts following pyrolysis were found to vary from 80 to 275 mm—indicating vertical shrinkage in a range of about 20% to 22%. The large variation in the shrinkage of the posts clearly indicates that different heights and sizes of SU-8 patterns induce different amounts of shrinkage during pyrolysis. Compared with positive photoresist (see FIG. 5), which have been shown to experience vertical shrinkage of about 74%, SU-8 gives less vertical shrinkage as well as better adhesion after pyrolysis.

Despite the good adhesion of SU-8 to a substrate, C-MEMS post patterns can peel from the substrate when using a one step pyrolysis process, e.g., at 900° C. in a vacuum furnace. The pyrolysis process described above using N2 and forming gas avoids this drawback and enables successful microfabrication of high aspect ratio C-MEMS structures. The problem is resolved due to (I) the bake process at the first temperature, which cross-links the SU-8 better, enhancing adhesion of the SU-8 posts to the substrate, (II) the multi-step heating process with its slow heating rate, which more effectively releases the stress from the adhesion of the SU-8 posts to the substrate which results in tensile stress in the carbon posts near the substrate interface, and (III) the slower de-gassing that occurs in a forming gas atmosphere. Heat-treatment during crosslinking generates gaseous by products and the subsequent out-gassing may cause the formation of micro-cracks which disintegrate the sample. In a vacuum, this outgassing would tend to be faster and thus more destructive

The pyrolyzed carbon posts produced in accordance with the process discussed above, were shown to exhibit reversible intercalation/de-intercalation of lithium. To confirm this feature, two different types of electrodes were studied. A first electrode was an unpatterned carbon film electrode, 1.6 mm thick, obtained from AZ 4620 photoresist on SiO₂/Si. The film electrode was designed to serve as a reference sample to determine whether pyrolyzed SU-8 exhibited electrochemically reversible intercalation/de-intercalation of lithium. The second electrode sample was a patterned electrode array obtained from SU-8 photoresist, consisting of 180×180 posts with a thickness of about 150 mm, on unpatterned carbon obtained from AZ 4620.

Electrochemical measurements were carried out using a 3-electrode Teflon cell that employed an o-ring seal to confine the working electrode to a surface area of about 6.4 cm² (circle of 2.86 cm diameter). In this way, the projected surface areas for both types of electrodes were identical. The carbon electrodes served as the working electrode while lithium ribbon (99.9% pure, Aldrich) was used as both the counter and reference electrode. The electrolyte was 1 M LiClO₄ in a 1:1 volume mixture of ethylene carbonate (EC) and dimethyl carbonate (DMC). All the cells were assembled and tested in an argon filled glove box in which both the oxygen and moisture levels were less than 1 ppm.

Galvanostatic and voltammetry experiments were carried out on both types of cells. For the galvanostatic measurements, the current was based on the C/5 rate for graphite (corresponding to 50 mA and 580 mA for unpatterned and patterned films, respectively) and cells were cycled between 10 mV and 1 V vs. Li/Li+. The voltammetry experiments were carried out using a sweep rate of 0.1 mV/s over the potential range 10 mV to 2 V vs. Li/Li+. All the electrochemical measurements were performed with a computer-controlled Arbin multi-channel station. A Hitachi S-4700-2 field-emission scanning electron microscope (FESEM) was used to characterize the C-MEMS structures.

In the non-patterned film carbon electrodes, the electrochemical behavior is similar to that of coke electrodes with no evidence of staging plateaus and a sloping profile. The galvanostatic measurements of the unpatterned film electrode show a large irreversible capacity on the first discharge followed by good cycling behavior, which is also consistent with the behavior of coke. These results are best characterized by considering the surface area normalized lithium capacity, which is determined to be 0.070 mAh cm⁻² for the second and subsequent cycles. The gravimetric capacity can be estimated by knowing the film thickness and density. For a fully dense film, this corresponds to ˜220 mAh g⁻¹, which is within the range of reversible capacities reported for coke.

The patterned carbon electrodes exhibit the same general electrochemical behavior. The voltammogram in FIG. 7B, for cycles two and three, is virtually identical to that of the unpatterned film electrode. The shoulder at 0.8 V is more pronounced but all other features are the same. Thus, there is no question that the C-MEMS electrode array is electrochemically reversible for lithium and that the characteristics of the pyrolyzed SU-8 array are similar to that of coke. The galvanostatic measurements in FIG. 7A were found to give a surface area normalized discharge capacity of 0.125 mA cm⁻² for the second and succeeding cycles. Thus, the C-MEMS electrode array possesses nearly 80% higher capacity than that of the unpatterned carbon film, for the same defined working electrode area of 6.4 cm². The reason for the greater capacity arises from the additional active area of the posts. The C-MEMS array has a higher internal resistance leading to a significant overpotential, which can be seen in the voltage steps at the beginning of each charge/discharge. This higher resistance arises from the fact that the height of the posts is nearly two orders of magnitude larger than the thickness of the unpatterned film. By applying smaller currents, the overpotential can be reduced significantly and the capacity increases.

As such, the C-MEMS architecture, i.e., high aspect ratio C-MEMS carbon electrode arrays, produced in accordance with the process described herein, constitute a powerful approach to building 3D carbon microelectrode arrays. Because these C-MEMS array electrodes exhibit reversible intercalation/de-intercalation of lithium, they can be used for microbattery applications. Such arrays may be connected with C-MEMS leads and enable switching to high voltage or high current depending on the application at hand. As discussed in greater detail below, the process described herein can be used to fabricate both the current collector and the electrodes, which simplifies the architecture and design of electrochemical systems such as 3D batteries. As depicted in FIGS. 8A and 8B, C-MEMS carbon electrode arrays 222 and carbon current collector 220 with negative and positive contacts 223 and 225 are shown formed on top of a substrate 214.

Creating high-aspect-ratio C-MEMS structures from photoresist is challenging with a single exposure step due to the UV light not being able to reach the bottom of the structure during the exposure step. Also, the C-MEMS pyrolysis process makes fabricating interconnects for carbon electrodes because a suitable conductive material must be able to survive the harsh temperature conditions of the C-MEMS pyrolysis process. However, forming high-aspect-ratio C-MEMS structures and connecting electrodes is easily accomplished by aligning multiple layers of C-MEMS structures. Specifically, photoresist can be patterned in layers creating multi-layer structures because a layer of photoresist can be applied on top of an existing layer of photoresist and then patterned using photolithography. Photopatterned/cross-linked SU-8 on the lower layers can go through multiple bake-exposure-development steps without damage. The multi-layer structures survive pyrolysis with only isotropic shrinkage, and retain its good adhesion to the substrate.

The main advantage of using C-MEMS carbon interconnects with respect to other methods (i.e., using thick metal layers, applying conductive pastes, and physically contacting the carbon using metal wires) is that it constitutes a simple method to integrate connection networks into the fabrication of C-MEMS devices. The interconnects are easy to pattern, and no etching or other steps other than the photolithography process are needed. Another advantage is that the contact between contact lines and electrodes is very good; since both are made from the same material. Also, because the carbon adheres well to the wafer and the layers of carbon are well connected, there is no need to worry about the mechanical integrity of the interface between layers. One other advantage is that since no additional materials such as metals are introduced, there is no contamination of the carbon during pyrolysis due to diffusion, adsorption, or absorption of a different species at the high temperatures.

An embodiment of the process 200 to form high aspect ratio C-MEMS carbon electrodes 222 and carbon interconnects 220 is depicted in FIG. 9. At step 1, a first layer of negative photoresist 212, preferably SU-8, is spun onto a substrate 214, such as SiO₂(5000 Å)/Si, using a two-step spinning process. Table 1 shows the preferred lithography processing parameters for various thicknesses of SU-8.

TABLE 1
The lithography preferred processing parameters for various thickness of SU-8

| SU-8 | | Spin speeds and times | | | | Exposure | Post exposure | |
|---|---|---|---|---|---|---|---|---|
| Thickness | Resist | Step 1 | Step 2 | Soft bake | | dose | bake (PEB) | |
| (μm) | Type | (12 sec.) | (30 sec.) | 65° C. | 95° C. | (mW/cm²) | 65° C. | 95° C. |
| 25 | SU-8 25 | 500 | 2000 | 3 min | 10 min | 200 | 1 min | 3 min |
| 100 | SU-8 100 | 500 | 3000 | 10 min | 40 min | 400 | 1 min | 10 min |
| 200 | SU-8 100 | 500 | 1500 | 15 min | 90 min | 450 | 1 min | 30 min |

The wafer 210 is then soft baked at step 2 using a two step process in an oven or hot plate to remove solvents from the photoresist 212. The bake time depends on the thickness of SU-8 and is given for three different thicknesses in Table 1. After a relaxation time of at least ten minutes, the SU-8 photoresist is exposed to UV light at step 3 in an aligner through a photo mask 216. The exposure dose is given in the Table 1. After exposure, the wafer is post exposure baked at step 4 using a two-step process. The post exposure bake (PEB) times are given in the Table 1. The PEB in step 4 allows the photoresist to harden. After another relaxation time of at least 10 minutes, the SU-8 is developed at step 5 in an SU-8 developer solution (usually PGMEA) until all unexposed SU-8 is removed and SU-8 interconnects 218 are formed. The next layer of SU-8 213 is spun on top of the existing layer 218 at step 6. The wafer 210 is then soft baked at step 7. After a relaxation time of at least ten minutes, the SU-8 photoresist is exposed to UV light at step 8 in an aligner through a photo mask 217. After exposure, the wafer is PEB at step 9. After another relaxation time of at least 10 minutes, the SU-8 layer 213 is developed at step 10 in an SU-8 developer solution (usually PGMEA) until all unexposed SU-8 is removed and SU-8 posts 219 are formed.

The soft bake times, exposure doses and PEB times of this process 200, which are related to the SU-8 thickness, will be different for different thicknesses. Additionally, the development steps for each layer can be skipped, and the whole device can be developed in a single step.

After creating the multilayer SU-8 structure, it is pyrolyzed at step 11 in an open ended furnace under an inert atmosphere. A two step pyrolysis is performed at two different temperatures; first, the samples are hard-baked at 300° C. for about 30-40 minutes and then ramped up to about 900-1000° C. under an N2 atmosphere. The first 300° C. step preferably removes any remaining solvents and ensures more complete cross-linking of the SU-8. Samples are held at about 900-1000° C. for about 60 minutes under a forming gas, preferably 95%N2/5%H2. The samples are then cooled down in an N2 atmosphere to room temperature. Nitrogen and forming gas are set to flow at 2000 sccm during and after pyrolysis. The heating rate is preferably about 10° C./min and the total cooling time is about 8-9 hours.

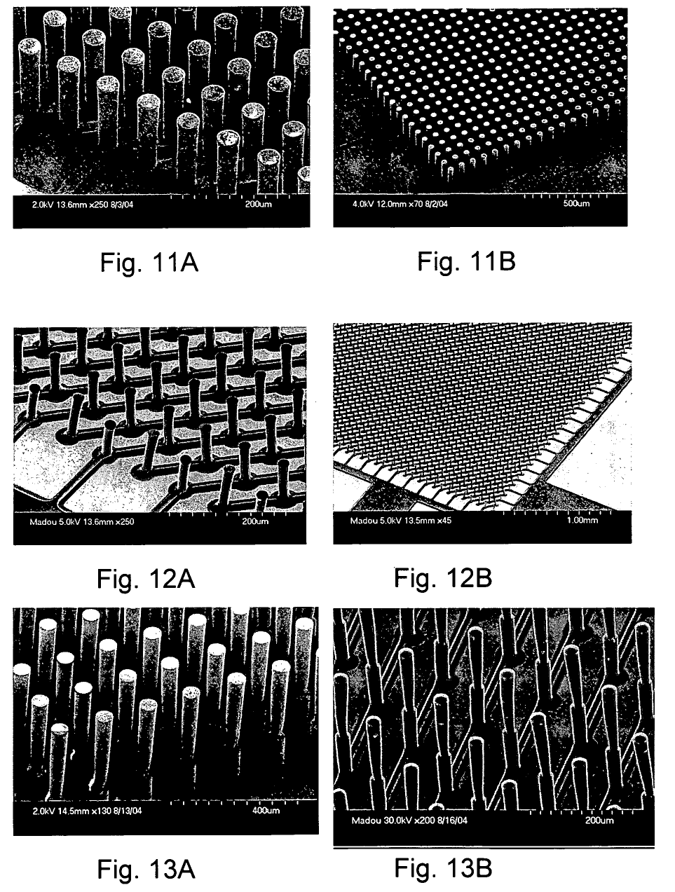

FIGS. 11A and 11B are SEM photos showing (11A) a close-up view and (11B) a low magnification of a two layer SU-8 structure. In this structure, the first layer was patterned to be an interconnect layer, and the second layer was patterned to be micro electrodes posts. FIGS. 12A and 12B are SEM photos showing (12A) a close-up view and (12B) a low magnification view of a two layer carbon structure corresponding to the structure shown in FIGS. 11A and 11B after pyrolysis.

Referring to FIG. 10, an embodiment of a process 300 to form multi-layer high aspect ratio C-MEMS carbon electrodes 322 and 324 and carbon interconnects 320 is depicted. At step 1, a first layer of negative photoresist 312, preferably SU-8, is spun onto a substrate 314. The wafer 310 is then soft baked at step 2. After a relaxation time of at least ten minutes, the SU-8 photoresist is exposed to UV light at step 3 in an aligner through a photo mask 316. After exposure, the wafer is post exposure baked at step 4 using a two-step process. The PEB in step 4 allows the photoresist to harden. After another relaxation time of at least 10 minutes, the SU-8 is developed at step 5 in an SU-8 developer solution (usually PGMEA) until all unexposed SU-8 is removed and SU-8 interconnects 318 are formed. The next layer of SU-8 313 is spun on top of the existing layer 318 at step 6. The wafer is then soft baked at step 7. After a relaxation time of at least ten minutes, the SU-8 photoresist 313 is exposed to UV light at step 8 in an aligner through a photo mask 317. After exposure, the wafer was post exposure baked at step 9. After another relaxation time of at least 10 minutes, the SU-8 layer 313 is developed at step 10 in an SU-8 developer solution (usually PGMEA) until all unexposed SU-8 is removed and SU-8 posts 319 are formed. At step 11, steps 6 thru 10 are repeated to form a set of posts 321 aligned on top of the first set of posts 319.

After creating the multilayer SU-8 structure, it is pyrolyzed at step 12 as described in regard to step 11 of FIG. 9 creating multi-layer high aspect ratio carbon electrode posts 322 and 324 aligned on top of one another and carbon interconnects 320. FIGS. 13A and 13B are SEM photos showing (13A) a three layer SU-8 structure with the first layer patterned to be an interconnect layer, and the second and third layers were patterned sequentially to achieve higher aspect ratio micro electrodes (posts) for use in microbattery applications; and (13B) a three layer carbon structure corresponding to the structure in FIG. 13A after pyrolysis.

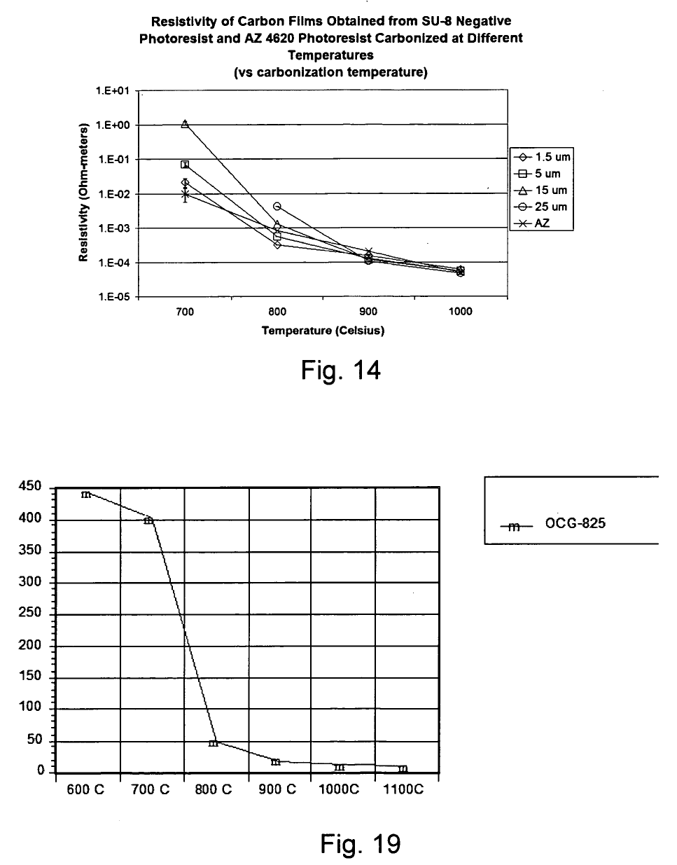

A disadvantage of using carbon interconnects is that carbon, although a great electrochemical material, is not an excellent electrical conductor. Experimentally determined resistivity values for carbon at different temperatures are shown in FIG. 14. Specifically, the graph shows the resistivity of carbon films obtained from AZ P4620 photoresist and various-thickness SU-8 films after one hour of heat treatment at different temperatures. The values were calculated from sheet resistance and thickness measurements assuming homogeneity of material. Each line represents a different resist type or thickness. Error bars represent±1 SD. (Some error bars are too small to be seen.)

The experimental results show that the resistivity (ρ) of carbon obtained from SU-8 is about 1×10⁻⁴ Ω·m for SU-8 -derived carbon heat treated at about 900° C., and about 5×10⁻⁵ Ω·m for SU-8 -derived carbon heat treated at about 1000° C. The resistance of the carbon interconnects is too high for most useful battery applications, and it creates problems if the carbon interconnects are used in a high conductivity solution to apply electrical fields because of the ohmic loss within the interconnect lines. Thus, in applications where the internal resistance of the device is of significant importance, such as batteries, application of electrical fields within a solution, and the like, metal interconnects tend to be more desirable.

The main advantages of using metal interconnects with respect to other methods, e.g., using carbon interconnects, applying conductive pastes, physically contacting the carbon using metal wires and the like, are that the metal interconnects have a very high conductivity, especially when compared to using carbon interconnects. The resistivities of silver, copper, and gold are 1.6×10⁻⁸ Ω·m, 1.7×10⁻⁸ Ω·m, 2.2×10⁻⁸ Ω·m, respectively. Thus, silver, copper, or gold tend to be 2200-6700 times less resistive than carbon material. Another advantage is that metal interconnects tend to be very robust, especially when compared to conductive pastes and physical contact.

In one embodiment, a process used to create high-conductivity interconnect traces to connect C-MEMS carbon structures includes depositing a metal layer, such as Ag, Au, Ni, Pt, Ti, and the like, on a substrate. The metal layer can be deposited using sputtering, evaporation, and other method of metal deposition. An adhesion layer, e.g., Cr or Ti for silicon substrates, can may be used to promote adhesion of the metal layer to the substrate. The metal is then patterned using a patterning method such as lift-off, etching, and the like. A polymer precursor is then patterned on top of the metal layer, and then pyrolyzed to create a C-MEMs electrode structure coupled to metal interconnects. The polymer precursor can be a negative photoresist such as SU-8 and the like, and can be patterned and then pyrolyzed in in accordance with the method depicted and described herein. High aspect ratio carbon structures can be microfabricted on top of these interconnects or alternatively on a carbon layer microfabricated on top of the interconnects. The layer can be pyrolyzed before or after the high aspect ratio structures have been patterned.

The pyrolysis process can be harsh and, in some instances, cause the metal layer to melt resulting in beading or discontinuity in the metal layer. This problem is overcome by using refractory metals, carbon based metal allows, and/or substrates with high surface energy.

SU-8 -derived carbon has been patterned on top of a silver layer (˜2000 Å). The silver layer was adhered to a Si substrate using a Cr adhesion layer (˜200 Å). Thick gold films on Si/SiO₂ substrates have also been used as current collectors for battery half cell experiments. Similarly, nickel was adhered to a SiO2 substrate and silicon nitrate substrate using a Cr adhesion layer, and then patterned to form interconnects.

In a detailed example, Ni interconnects were formed by coating Ni onto a substrate. The process included the following steps: step 1, deposit 1000 Å Cr onto the substrate using a thermal evaporator; step 2, deposit 4000 Å Ni onto the Cr adhesion layer using a thermal evaporator; step 3, pattern the Ni and Cr layer using etchant solutions; step 4, deposit a layer of photoresist onto the patterned Ni and Cr layer—the photoresist preferably being a negative photoresist for high aspect ratio structures; step 5, pattern and develop the resist—preferably by aligning the photoresist mask with the patterns of the patterned Ni and Cr layer; step 6, pyrolyze the photoresist to create the C-MEMs with metal interconnect structure—preferably applying the multi-step pyrolysis process described herein for the fabrication of high aspect ratio carbon structures.

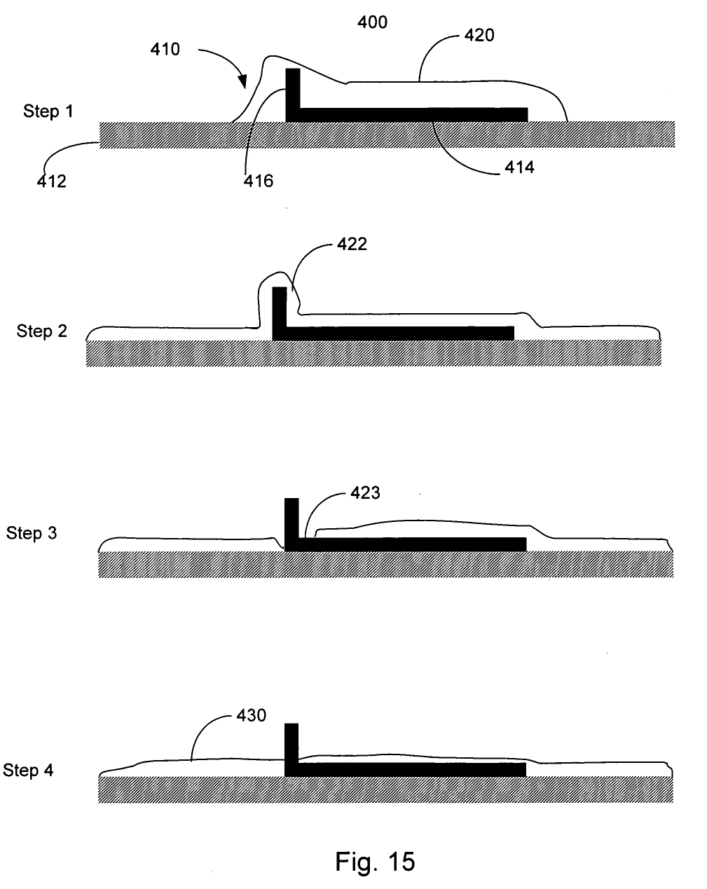

Turning to FIGS. 15-18, there are many applications where insulation of the interconnects while exposing only the electrodes is desirable. An example is that of using electrodes in a liquid. It is often desirable to prevent the interconnects from interacting with the liquid media. Conventionally methods do not provide an adequate method for insulating the interconnects of high-aspect-ratio structures. In one embodiment, a method is provided for self-aligned insulation of interconnects to high-aspect-ratio structures, such as C-MEMS carbon structures described herein, by flowing a photoresist layer during a high-temperature hard bake. Advantageously, the method can be used to easily insulate the bottom interconnect layer that connects high-aspect-ratio electrodes.

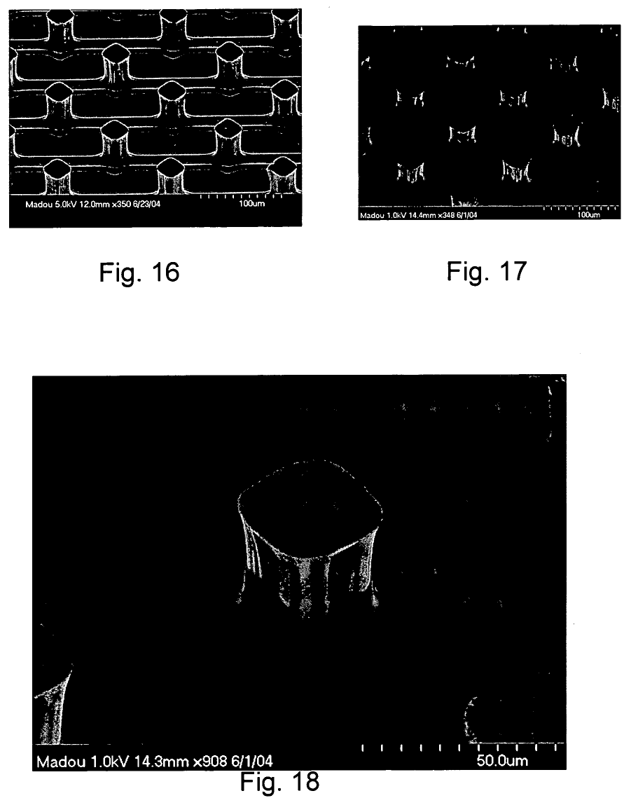

FIG. 16 is a SEM photo of high-aspect-ratio C-MEMS electrodes and their interconnects. In FIG. 17, which is a SEM photo, the electrodes of a high-aspect-ratio C-MEMS are shown protruding from an insulating layer. FIG. 18 provides a close-up SEM photo of one of the high-aspect-ratio C-MEMS electrodes protruding from an insulating layer.

Photoresists are usually non-conductive and can be patterned. If the photoresist is allowed to flow, the photoresist will flow until it reaches a very high-aspect-ratio structure. FIG. 19 shows the typical resistance/pyrolysis temperature curve for a photoresist. As depicted, the photoresist becomes more conductive at higher temperatures.

In the insulation method for C-MEMS devices described in greater detail below, one photoresist (the one to be carbonized) is treated to high temperatures (above about 800 degrees) to change it into a conductive material. The glass transition temperature (Tg) becomes higher as the photoresist is treated to high temperatures. The pyrolysis is done slowly to insure that the current temperature is always below Tg because to preserve the shape of the photoresist structures to be carbonized. Another photoresist (the insulation layer) is baked such that the final temperature is high enough to harden the resist and to strengthen the resist to chemical attack, but low enough to insure that the resist is not conductive (typically below about 600 degrees). To enable the resist to flow and self-align about the interconnects, the temperature is ramped up quickly.

Preferably, the insulation method involves applying a photoresist onto the interconnects and the high-aspect-ratio electrodes of a high-aspect ratio device. The device or wafer is then spun so that the excess photoresist is removed. A photolithographic process is utilized in an aligner to remove photoresist that is on and in the vicinity of the high-aspect-ratio electrodes. Finally, the photoresist layer is hard-baked at a temperature higher than the glass transition temperature to allow the layer to flow. The photoresist layer then flows until it reaches the bottom of the high-aspect-ratio electrodes creating a self-aligned insulation layer over and about the interconnects.

An exemplary embodiment of the insulation method 400 is described in detail in regard to FIG. 15. At step 1, a positive photoresist 420, such as Shipley 1827, is applied liberally to a a device 410 with high aspect ratio electrodes 416 such as a C-MEMS device or wafer fabricated in accordance with the process described herein. The high aspect ratio posts 416 are adhered to interconnects 414, carbon or metal, which are adhered to a substrate 412. At step 2, the wafer 410 is spun at high speeds to remove the excess photoresist 420 (e.g., 3000 rpm for 30 seconds). Then, at step 3, a window 423 is opened or cut around the high-aspect-ratio structures 416 using the photolithographic process to remove the photoresist 422 around the high-aspect-ratio structures 416. Next, at step 4, the photoresist layer 420 is hard baked for about 15 minutes at about 120° C. and about 5 minutes at about 140° C. to enable the resist to flow. The need for precise alignment of the insulation is circumvented due to the self-aligning nature of the flowing photoresist. As shown at step 4, in the final device 410, only the higher portions of the high-aspect-ratio electrodes 416 are exposed to the environment, while the interconnects 414 are insulated underneath the insulation layer 430.

Although the preceding discussion has primarily focused on high aspect ratio carbon posts, the systems and methods described herein can be used to fabricate a variety of structures.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit of the disclosure. Furthermore, it should also be understood that the features or characteristics of any embodiment described or depicted herein can be combined, mixed or exchanged with any other embodiment.

1. A process for forming high aspect ratio carbon structures comprising the steps of
patterning a carbon precursor polymer on a substrate, and
pyrolyzing the patterned carbon precursor polymer in a multi-step pyrolysis process in an inert and forming gas atmospheres while trailing the glass transition temperature of the patterned carbon precursor polymer.

2. The process of claim 1 wherein the carbon precursor polymer is a negative photoresist.

3. The process of claim 2 wherein the negative photoresist comprises SU-8 photoresist.

4. The process of claim 2 wherein the patterning step comprises photopatterning the negative photoresist.

5. The process of claim 2 wherein the step patterning includes the steps of
spin coating a film of the negative photoresist on to the substrate,
soft baking the negative photoresist and substrate,
exposing the photoresist to UV light with a mask,
post baking the photoresist, and
developing the photoresist.

6. The process of claim 1 wherein the pyrolyzing step includes
baking the patterned carbon precursor polymer at a first temperature for a first predetermined period of time in an inert gas atmosphere,
heating the patterned carbon precursor polymer to a second predetermined temperature in the inert gas atmosphere, and
heating the patterned carbon precursor polymer at the second temperature for a second predetermined period of time in a forming gas atmosphere.

7. The process of claim 5 further comprising the step of cooling the patterned carbon precursor polymer to a third temperature.

8. The process of claim 1 wherein the patterning step includes patterning first and second layers of the carbon precursor polymer.

9. The process of claim 8 wherein the first layer is patterned as interconnects for electrodes and the second layer is patterned as electrodes and aligned on top of the interconnects.

10. The process of claim 8 wherein the first layer is patterned as a first section of an electrode and the second layer is patterned as a second section of the electrode.

11. The process of claim 9 wherein the patterning step includes patterning a third layer wherein the second and third layers are patterned as the first and second sections of the electrodes.

12. The process of claim 1 further comprising the step of reducing the internal electrical resistance of a device comprising the high aspect ratio carbon structures.

13. The process of claim 12 wherein the reducing the internal electrical resistance step includes patterning a layer of metal on the substrate to act as electrode interconnects prior to patterning the carbon precursor polymer.

14. The process of claim 1 further comprising the step of self aligning insulation over interconnects of a device comprising the high aspect ratio carbon structures coupled to the interconnects.

15. A process of minimizing the internal resistance of C-MEMs based electrochemical device comprising the steps of
depositing a layer of metal on a substrate,
patterning the layer of metal to form electrical interconnects on the substrate,
patterning carbon precursor polymer structures over the metal interconnects, and
carbonizing the carbon precursor structures.

16. The process of claim 15 wherein the metal is a refractory metal.

17. The process of claim 15 wherein the metal is a carbon based metal alloy.

18. The process of claim 15 wherein the substrate is a high surface energy substrate.

19. The process of claim 15 wherein the patterning of carbon precursor polymer structures comprises patterning high aspect ratio structures on top of the interconnects.

20. The process of claim 19 wherein the carbon precursor polymer is a negative photoresist.

21. The process of claim 20 wherein the step of carbonizing the high aspect ratio structures includes a muti-step pyrolyzing process.

22. The process of claim 21 wherein the multi-step pyrolyzing process includes the steps of
heating the high aspect ratio structures at a first temperature for a first predetermined period of time in an inert gas atmosphere,
heating the high aspect ratio structures to a second predetermined temperature in the inert gas atmosphere, and
heating the high aspect ratio structures at the second temperature for a second predetermined period of time in a forming gas atmosphere.

23. The process of claim 22 further comprising the step of cooling the high aspect ratio structures to a third temperature.

24. A self aligning insulating process of interconnects in a device comprising high aspect ratio electrodes coupled to the interconnects, the process comprising the steps of
applying a layer of photoresist over the electrodes and interconnects, and
heating the photoresist to a temperature causing the photoresist to flow and self aligningly cover the interconnects.

25. The process of claim 24 further comprising the step of removing photoresist from around the electrodes.

26. The process of claim 25 wherein the photoresist is removed with a photolithography process.

27. The process of claim 26 wherein the photoresist is heated to a temperature above it glass transition temperature and below a temperature at which it becomes conductive.
